(19) United States
(12) Patent Application Publication
(10) Pub. No.: US 2006/0229972 A1
(43) Pub. Date: Oct. 12, 2006

(54) Live auction system

(76) Inventor: Jason Melo, Allston, MA (US)

Correspondence Address: KEVIN J. MCNEELY, ESQ., 5335 WISCONSON AVENUE, NW, SUITE 440, WASHINGTON, DC, 20015, US

(21) Appl. No.: 11/366,813

(22) Filed: Mar. 3, 2006

Related U.S. Application Data
(60) Provisional application No. 60/658,378, filed on Mar. 4, 2005.

(51) Int. Cl. G06Q 40/00

(52) U.S. Cl. 705/37

(57) ABSTRACT

A method of conducting an auction transaction via a global communication network includes receiving requests to participate in a live auction, incrementing a bid price for participants at periodic time intervals, acknowledging withdrawal by each of the participants until a last active participant remains in the live auction and designating the last active participant as the auction winner.

### CROSS REFERENCE TO RELATED APPLICATIONS

This utility patent application claims priority to U.S. provisional patent application 60/658,378 filed on Mar. 4, 2005, which is hereby incorporated by reference.

### BACKGROUND

Online Auctions have made purchasing and selling easier and more efficient then ever before in history. It is a trend that continues to grow rapidly giving businesses that utilize this technology a competitive advantage.

Some auction products may be perishable items that must be sold quickly. For example, fish is a commodity which may be caught at sea and must be sold and shipped within a few hours. Thus, a need exists for an auction system that can be used to quickly sell a perishable commodity.

### SUMMARY

In one general aspect, a method of conducting an auction transaction via a global communication network includes receiving requests to participate in a live auction, incrementing a bid price for participants at periodic time intervals, acknowledging withdrawal by each of the participants until a last active participant remains in the live auction and designating the last active participant as the auction winner.

Embodiments may include one or more of the following features. For example, the method may include assigning a floor price to begin the live auction.

As another feature, the method may include monitoring a network connection status of each of the participants and automatically withdrawing any of the participants with a failed network connection. In addition, the method may log the failed network connection information.

In another embodiment, the method may include allowing each of the participants to enter a maximum bid price and automatically withdrawing a participant from the live auction when the incremented bid price exceeds the maximum bid price of the participant.

As still another embodiment, the method includes capturing high resolution video images of the auction product and streaming the high resolution video images to the participants. The video image quality may be suitable that the product quality can be graded without an on-site visual inspection. As another feature, a zoom feature may be enabled to provide the participants with detailed views of the auction product.

Status updates may be provided to the participants in the live auction at periodic time intervals. Other information may also be provided to the participants, such as, for example, grading of the product quality.

The status updates may be provided by a partial refreshing of the screen view of each participant such that the entire page being viewed need not be reloaded.

As a prerequisite to auction participation, requesters may be pre-approved and/or authenticated prior to being allowed to participate in a live auction.

The auction winner may be notified of the winning bid price and the method of shipping, which may be a pre-specified shipping method. An electronic account of the auction winner may be debited for the winning bid price.

In another general aspect, an auction transaction system includes a sensor module connected to a communications network to monitor a connection status of auction participants, an auction server running an auction application that increments a bid price for the auction participants at periodic time intervals, acknowledges withdrawal by each participant until only a last participant remains in the live auction and designates the last participant as the auction winner and a camera that captures a high resolution video image of the auction product, the image being made available to each auction participant to evaluate product quality. The system may include one or more of the above features.

In still another general aspect, an auction software program includes a first code segment to receive a request from more than one party to be a participant in a live auction, a second code segment to increment a bid price for each participant at periodic time intervals, a third code segment to acknowledge withdrawal by each participant until only a last participant remains in the live auction and a fourth code segment to designate the last participant as the auction winner.

The program may include one or more of the above or following features. For example, the program may include a fifth code segment to refresh only a portion of a screen view of each participant.

### DESCRIPTION OF THE DRAWINGS

FIG. 1 shows a flowchart of a method of conducting a live auction;

FIGS. 2a-2e show screenshots viewed by bidders/participants during the live auction; and

FIG. 3 shows a block diagram of an auction system running on a communications network.

### DETAILED DESCRIPTION

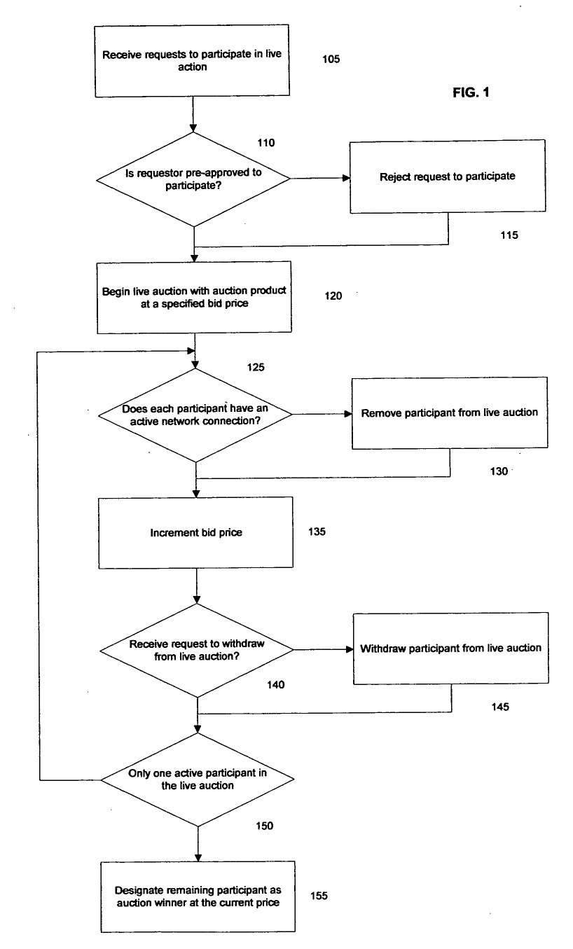

Referring to FIG. 1, a method of conducting an auction transaction includes receiving requests to participate in a live auction (step 105). The status of the requester is verified as a pre-approved auction participant (step 110). If the requestor is not pre-approved to participate, the requestor is rejected as a participant (step 115).

The auction begins at a specified floor price (step 120) and according to parameters established by the auction manager. For example, the auction may begin at a predetermined date and time and/or when a threshold number of participants are included in the live auction.

The method ensures that each participant has an active network connection (step 125). Any participant that loses their Internet connection is removed from the bidding (step 130) to prevent “ghost bidding.” The network connection may be checked at short time intervals, such as, for example, every quarter-second or half-second.

The bid price is incremented at periodic time intervals (step 135). The auction manager may vary the time or increment value depending on the nature of the auction product or other considerations.

When the bid price is incremented, the new price information is updated on each participant's viewing screen. However, instead of reloading the entire page, only the incremental price information is updated. This minimizes download delay time between when the bid price is incremented at the auction manager's site and when the updated information is received for viewing by each of the participants.

The auction participants are given the opportunity to withdraw from the live auction. The method monitors the live auction to determine whether any withdrawal instruction has been received (step 140). Withdrawing participants are removed from the bidding in the live auction (step 145).

The method allows participant withdrawal until only one active bidder remains in the live auction, referred to as the “last man standing” (step 150). The last man standing is deemed to be the auction winner and is awarded the sale of the auction product at the current bid price (step 150). Another live auction for the next auction product in the queue may then be initiated after a brief period of time.

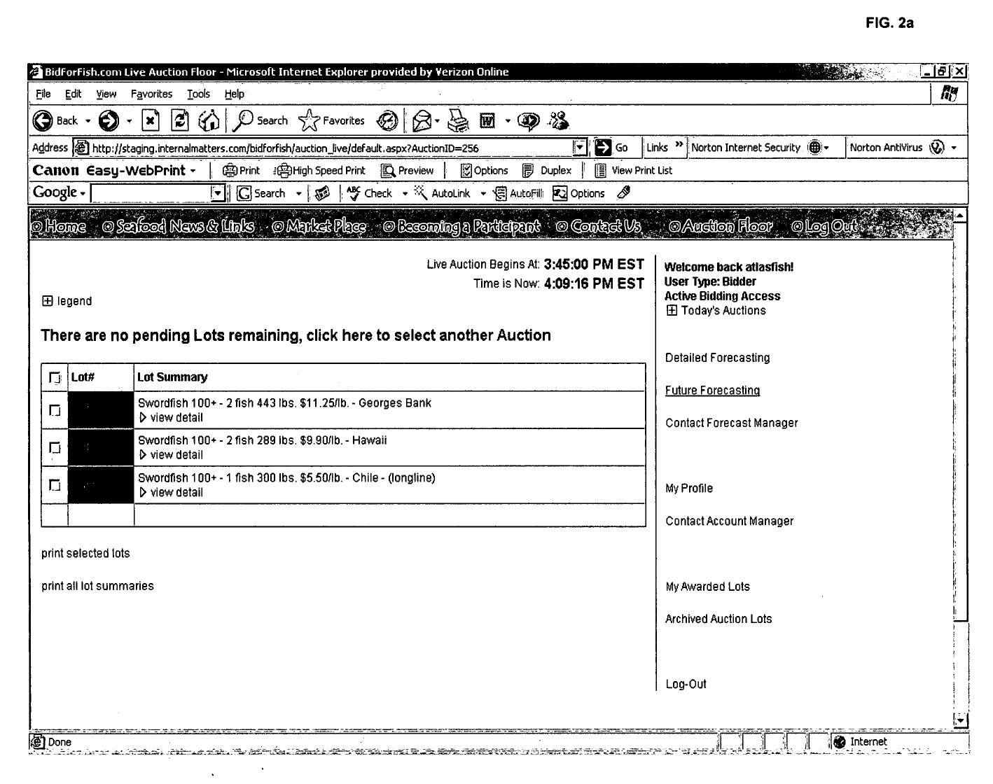

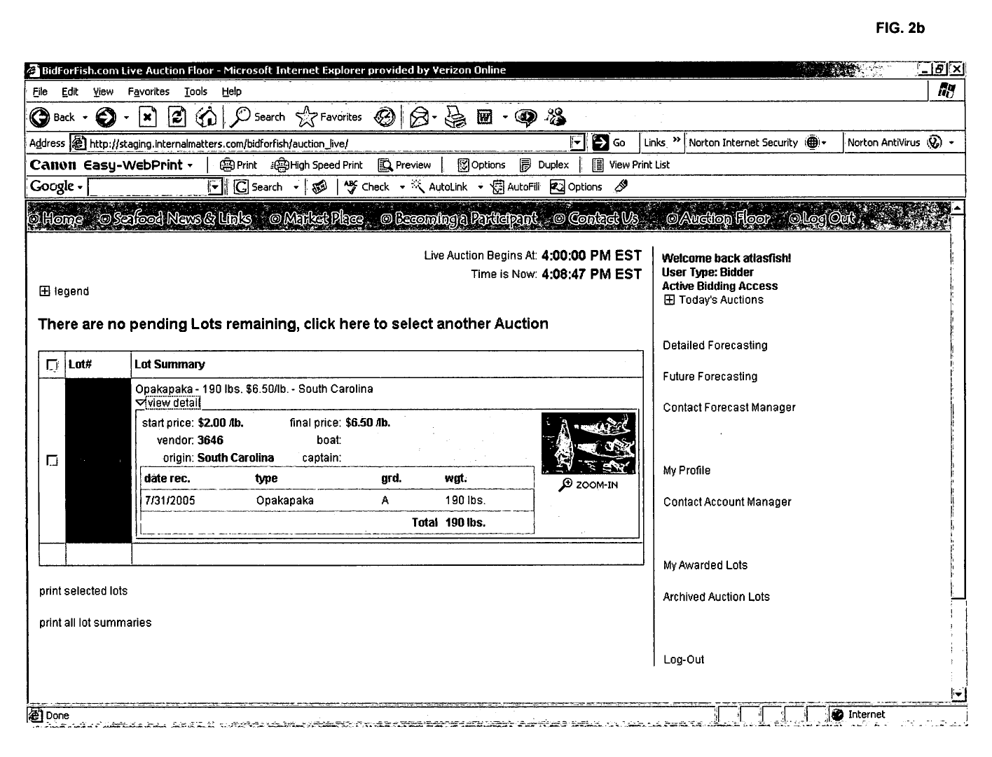

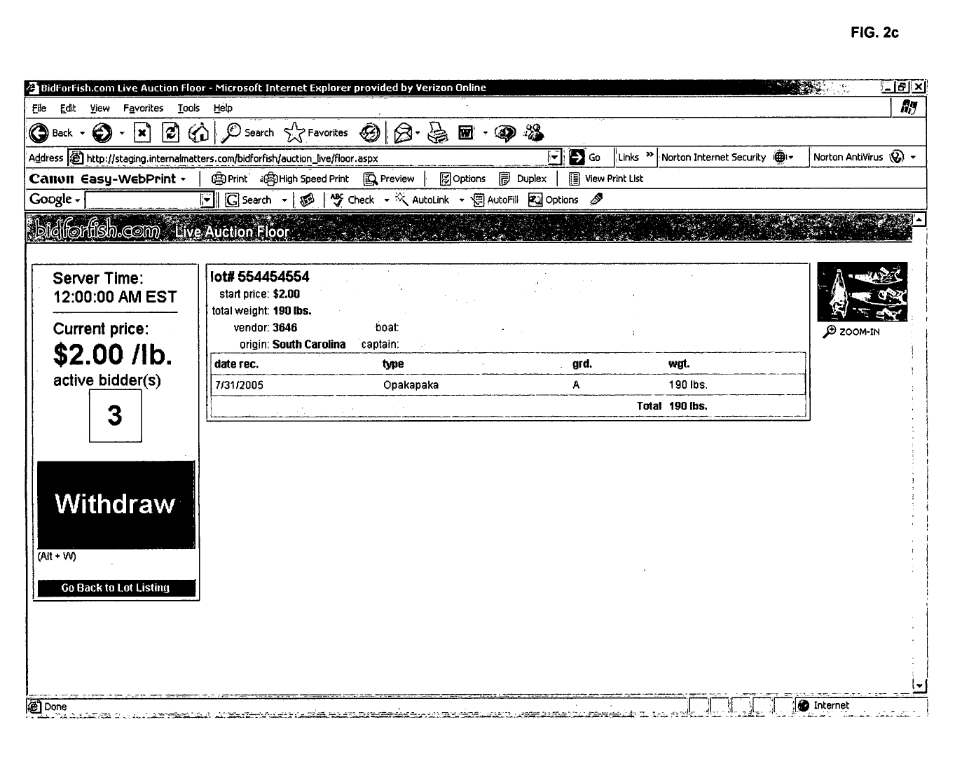

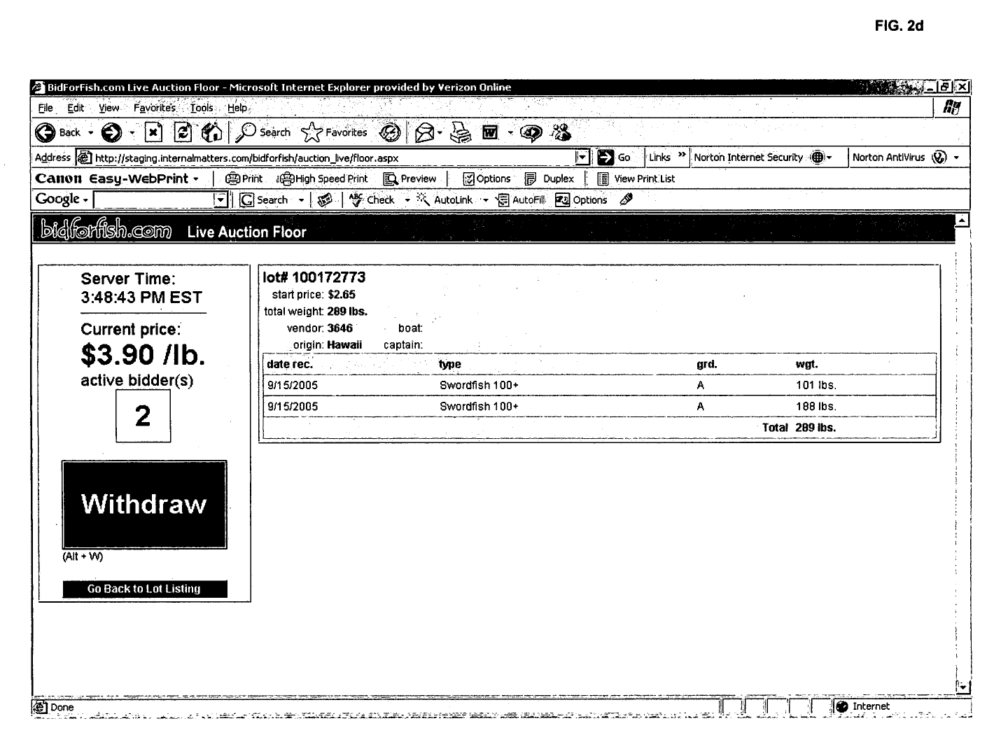

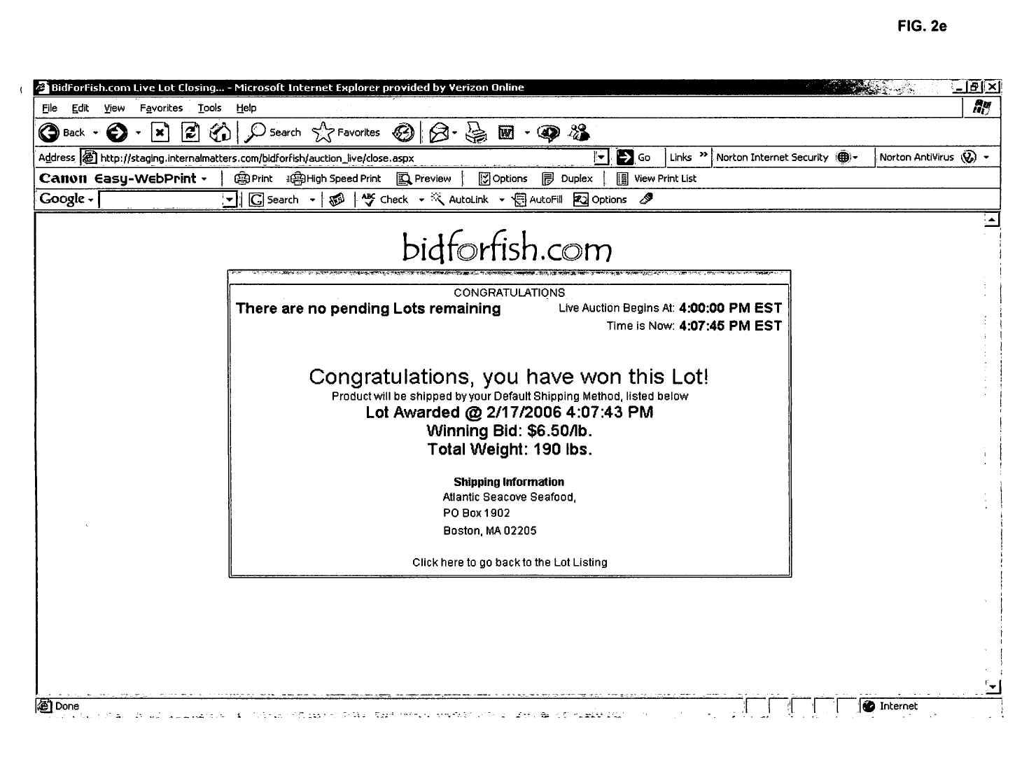

Screenshots of the live auction experience are shown in FIGS. 2a-2e. When the participant logs on to connect to the auction system server, the participant is presented with a menu of items available for auction for that day (FIG. 2a).

The participant can then select a specific auction lot to get more information (FIG. 2b). For example, the participant can get information about the product quality and get also get a high resolution image of the product. A zoom viewer allows the participant to closely inspect the auction product.

Upon commencement of a live auction, bidding begins at a floor price which, as shown in FIG. 2c, starts at $2.00/lb. The participants can view the actual number of participants in the live auction and they also view a large orange withdraw button which can be clicked or actuated at any time to withdraw from the bidding.

The bid price is incremented upward from the floor price at periodic time intervals (FIG. 2d) until there are only two remaining auction participants. When the second to last participant withdraws, the last man standing is the auction winner and he is presented with a screen that displays information about the winning bid (FIG. 2e).

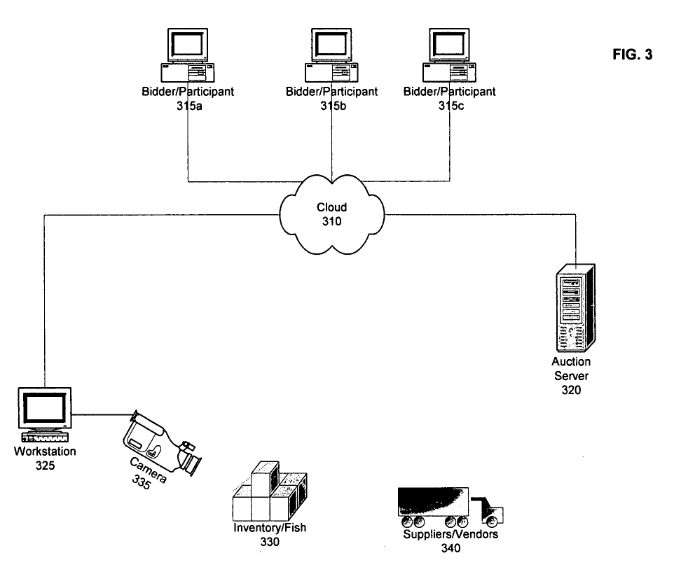

Referring to FIG. 3, a communications network 310 connects the bidders or participants 315a-315c to the live auction system. A server 320 which runs the auction software application is also connected to the network 310.

A workstation 325 at the auction or inventory site 330 is used to manage the live auction process. For example, the workstation can be used to specify the auction time and date, bid floor price, bid increments, bid increment timing and other live auction parameters.

A camera 335 is used to capture high resolution images of the auction inventory which is brought in by suppliers/vendors 340. The images can be uploaded to the communications network 310 via the workstation 325. The bidder/participants 315a-315c can access a zoom feature such that the inventory can be carefully inspected.

I claim:

1. A method of conducting an auction transaction via a global communication network, comprising:
receiving requests to participate in a live auction;
incrementing a bid price for participants at periodic time intervals;
acknowledging withdrawal by each of the participants until a last active participant remains in the live auction; and
designating the last active participant as the auction winner.

2. The method of claim 1, further comprising:
assigning a floor price to begin the live auction;
wherein incrementing comprises incrementing the bid price from the floor price.

3. The method of claim 1, further comprising:
monitoring a network connection status of each of the participants; and
automatically withdrawing any of the participants with a failed network connection.

4. The method of claim 3, further comprising:
logging the failed network connection information.

5. The method of claim 1, further comprising:
allowing each of the participants to enter a maximum bid price; and
automatically withdrawing a participant from the live auction when the incremented bid price exceeds the maximum bid price of the participant.

6. The method of claim 1, further comprising:
capturing high resolution video images of the auction product; and
streaming the high resolution video images to the participants.

7. The method of claim 6, further comprising:
grading a product quality of the auction product based on the high resolution video images.

8. The method of claim 6, further comprising:
enabling a zoom feature to provide the participants with detailed views of the auction product.

9. The method of claim 1, further comprising:
providing a status update to the participants in the live auction.

10. The method of claim 1, further comprising:
grading a product quality of the auction product.

11. The method of claim 10, further comprising:
posting the product quality of the auction product.

12. The method of claim 1, further comprising:
refreshing a screen view of each of the participants in the live auction.

13. The method of claim 12, wherein refreshing the screen view includes refreshing only a portion of the screen view.

14. The method of claim 1, further comprising:
authenticating each of the participants as a pre-approved auction participant.

15. The method of claim 1, further comprising:
notifying the auction winner of the winning bid price.

16. The method of claim 1, further comprising:
debiting an electronic auction payment account of the auction winner in an amount that includes a last incremented bid price.

17. The method of claim 1, further comprising:
preparing a shipping order to deliver the auction product to the auction winner.

18. An auction transaction system, comprising:
a sensor module connected to a communications network to monitor a connection status of auction participants;
an auction server running an auction application that increments a bid price for the auction participants at periodic time intervals, acknowledges withdrawal by each participant until only a last participant remains in the live auction and designates the last participant as the auction winner; and
a camera that captures a high resolution video image of the auction product, the image being made available to each auction participant to evaluate product quality.

19. An auction software program, comprising:
a first code segment to receive a request from more than one party to be a participant in a live auction;
a second code segment to increment a bid price for each participant at periodic time intervals;
a third code segment to acknowledge withdrawal by each participant until only a last participant remains in the live auction; and
a fourth code segment to designate the last participant as the auction winner.

20. The auction software program of claim 19, further comprising:
a fifth code segment to refresh only a portion of a screen view of each participant.
